(19) United States
(12) Patent Application Publication
(10) Pub. No.: US 2012/0311178 A1
(43) Pub. Date: Dec. 6, 2012

(54) SELF-DISRUPTING NETWORK ELEMENT

(75) Inventors: Nausheen Naz, Ottawa (CA); Csaba Marton, Ottawa (CA); Suat R. Eskicioglu, Ottawa (CA); Manikka Thyagarajan, Ottawa (CA); Michael H. Lashley, Chateauguay (CA)

(73) Assignee: ALCATEL-LUCENT CANADA INC., Ottawa (CA)

(21) Appl. No.: 13/149,414

(22) Filed: May 31, 2011

(51) Int. Cl. G06F 15/16

(52) U.S. Cl. 709/234

(57) ABSTRACT

A method, apparatus, and machine readable storage medium is disclosed for establishing a test protocol processor which identifies and removes messages from a network element port buffer. Subsequent to removal the test protocol processor may perform one of several actions including allowing the message to drop, replacing the message after a delay, replacing the message after altering the payload of the message, and replacing the message after altering the message type. The disclosed self disrupting network element is particularly useful for providing a means to perform in situ field testing of network performance indicators.

### CROSS-REFERENCE

This application cross-references the following co-pending application, incorporated by reference herein: Application Serial No. [to be determined], Attorney Docket No. ALC 3732, “AUTONOMOUS SELF-DISRUPTING NETWORK ELEMENT” to Naz et al., filed May 31, 2011.

This application cross-references the following co-pending application, incorporated by reference herein: Application Serial No. [to be determined], Attorney Docket No. ALC 3728, “MESSAGE FLOW REROUTING FOR SELF-DISRUPTING NETWORK ELEMENT” to Thyagarajan et al., filed May 31, 2011.

This application cross-references the following co-pending application, incorporated by reference herein: Application Serial No. [to be determined], Attorney Docket No. ALC 3729, “MESSAGE FLOW REROUTING FOR AUTONOMOUS SELF-DISRUPTING NETWORK ELEMENT” to Naz et al., filed May 31, 2011.

This application cross-references the following co-pending application, incorporated by reference herein: Application Serial No. [to be determined], Attorney Docket No. ALC 3730, “FIELD-DEPLOYABLE PROTOCOL MESSAGE INTERCEPTOR” to Thyagarajan et al., filed May 31, 2011.

This application cross-references the following co-pending application, incorporated by reference herein: Application Serial No. [to be determined], Attorney Docket No. ALC 3731, “FIELD-DEPLOYABLE MESSAGE COMPROMISER” to Thyagarajan et al., filed May 31, 2011.

### FIELD OF THE INVENTION

The invention relates to generally to network element equipment testing and is particularly concerned with demonstrating the performance of network elements against performance indicators.

### BACKGROUND OF THE INVENTION

As demand increases for varying types of applications within mobile telecommunications networks, service providers constantly upgrade their systems in order to reliably provide an expanded functionality. What was once a system designed simply for voice communication has grown into an all-purpose network access point, providing access to a myriad of applications including text messaging, multimedia streaming, and general Internet access. In order to support such applications, providers have built new networks on top of their existing voice networks. As seen in second and third generation networks, voice services must be carried over dedicated voice channels and directed toward a circuit-switched core, while other service communications are transmitted according to the internet protocol (IP) and directed toward a different, packet-switched core. This led to unique problems regarding application provision, metering and charging, and quality of experience (QoE) assurance.

Call drops and establishment failures are two of the major issues in wireless networks that impact end user experience and cause customer dissatisfaction. Metrics have been defined to track these statistics in the networks to evaluate network performance. These metrics are termed as Network Key Performance Indicators (N-KPI).

Demonstration of Network Key Performance Indicators as impacted by a particular network element is difficult to do. If a particular network element, such as for example a Radio Network Controller (RNC) of the Universal Mobile Telecommunications Services (UTMS) is situated in a test facility, then it is difficult to ensure that the test equipment which is exercising the RNC is providing conditions matching a particular customer network given the variety of network equipment that a given customer's network may present. On the other hand, once the network equipment is deployed into the customer's network the contextual conditions presented are representative, but disentangling the contributions, positive or negative, of the specific network equipment element becomes difficult due to interoperability effects.

In view of the foregoing, it would be desirable to provide a method to test a network element in situ in a customer network. In particular, it would be desirable to provide a means by which the response of a particular network element, functioning within an operational network, to problematic messaging conditions could be demonstrated.

### SUMMARY OF THE INVENTION

According to one aspect of the invention there is disclosed a network element having: a port having a port buffer; a standard protocol processor which processes messages stored in the port buffer; and a test protocol processor having access to the port buffer; wherein the test protocol processor is configured to remove a first protocol message from the port buffer in the event that the first protocol message corresponds to a predetermined message type.

In some embodiments of the invention the test protocol processor replaces the first protocol message in the port buffer after a delay. According to one embodiment of the invention the delay is chosen from a range of delays having a lower delay limit and an upper delay limit. According to another embodiment of the invention a chance of the delay being a particular delay is defined by a random distribution. In some versions of the invention the random distribution is a uniform random distribution. In some versions of the invention the random distribution is a truncated Normal random distribution. In some versions of the invention the random distribution is a truncated Poisson random distribution, and in some versions of the invention the random distribution is a truncated exponential random distribution.

According to another embodiment of the invention, the test protocol processor replaces the first protocol message in the port buffer after altering the payload contents of the first protocol message. According to another embodiment of the invention the test protocol processor replaces the first protocol message in the port buffer with a different protocol message. In some embodiments the different protocol message is a failure message.

Advantageously, in some embodiments of the invention the port buffer is an input port buffer of the network element; and the test protocol processor removes the first protocol message prior to the standard protocol processor processing the message.

Advantageously, in other embodiments of the invention the port buffer is an output port buffer of the network element and the test protocol processor removes the first protocol message prior to transmission of the first protocol message from the port.

Advantageously, in some embodiments of the invention the predetermined message type is one of a plurality of predetermined message types.

According to another aspect of the invention there is provided a method of testing a performance indicator for a network element having a port having a port buffer; a standard protocol processor which processes messages stored in the port buffer; a test protocol processor having access to the port buffer, and the test protocol processor configured to execute the method; the method having the steps of: checking whether a first protocol message in the port buffer corresponds to a predetermined message; and removing the first protocol message from the port buffer in the event that the first protocol message in the port buffer does corresponds to the predetermined message.

In some embodiments of the invention the method has the further step of replacing the first protocol message in the port buffer after a delay. In some versions of this embodiment of the invention the method has the further step of choosing the delay from a range of delays having an lower delay limit and an upper delay limit.

In some embodiments of the invention, the chosen delay has a chance of the delay being a particular delay as defined by a random distribution. In some versions of these embodiments, the random distribution is one of the set of a uniform random distribution, a truncated Normal random distribution, a truncated Poisson random distribution, and a truncated exponential random distribution.

In some embodiments of the invention the method has the further step of replacing the first protocol message in the port buffer after altering the payload contents of the first protocol message.

In some embodiments of the invention the method has the further step of replacing the first protocol message in the port buffer with a different protocol message. In some versions of this embodiment the different protocol message is a failure message.

In some embodiments of the invention the method has the checking step checking an input port buffer of the network element; and the removing step occurring prior to the standard protocol processor processing the message.

In some embodiments of the invention the method has the checking step checking an output port buffer of the network element the removing step occurring prior to transmission of the first protocol message from the port.

Advantageously, in some embodiments of the invention in the checking step the predetermined message type is one of a plurality of predetermined message types.

According to another embodiment of the invention there is provided a tangible and non-transitory machine-readable storage medium encoded with instructions thereon for execution by a test protocol processor; the test protocol processor disposed in a network element having a port having a port buffer; a standard protocol processor which processes messages stored in the port buffer; the test protocol processor having access to the port buffer; the instructions adapting the operation of the test protocol processor to perform a method; the method having the steps of checking whether a first protocol message in the port buffer corresponds to a predetermined message; and removing the first protocol message from the port buffer in the event that the first protocol message in the port buffer does corresponds to the predetermined message.

According to some embodiments of the invention, the tangible and non- transitory machine-readable storage medium is further encoded with additional instructions thereon having the additional step of replacing the first protocol message in the port buffer after a delay.

According to some embodiments of the invention, the tangible and non-transitory machine-readable storage medium is further encoded with additional instructions thereon having the additional step of replacing the first protocol message in the port buffer after altering the payload contents of the first protocol message.

According to some embodiments of the invention, the tangible and non- transitory machine-readable storage medium is further encoded with additional instructions thereon having the additional step of replacing the first protocol message in the port buffer with a different protocol message.

Note: in the following the description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

### BRIEF DESCRIPTION OF THE DRAWINGS

The present invention will be further understood from the following detailed description of embodiments of the invention, with reference to the drawings in which:

FIG. 1 illustrates an exemplary Universal Mobile Telecommunications Services (UMTS) network for providing various mobile services;

FIG. 2 illustrates an exemplary Radio Network Controller (RNC) with associated communication ports;

FIG. 3 illustrates an exemplary network element according to an embodiment of the invention;

FIGS. 4a, 4b, 4c and 4d illustrates a set of exemplary statistical distributions used in generating a random value; and

FIG. 5 illustrates an exemplary network element protocol processor assembly according to an embodiment of the invention.

### DETAILED DESCRIPTION

Referring now to the drawings, in which like numerals refer to like components or steps, there are disclosed broad aspects of various exemplary embodiments.

In use the invention is situated in a piece of network equipment which acts as a node in a network of network equipment. Embodiments of the present invention provide a self-disrupting network element wherein the network element itself can disrupt protocol messages received at the network element or transmitted from the network element.

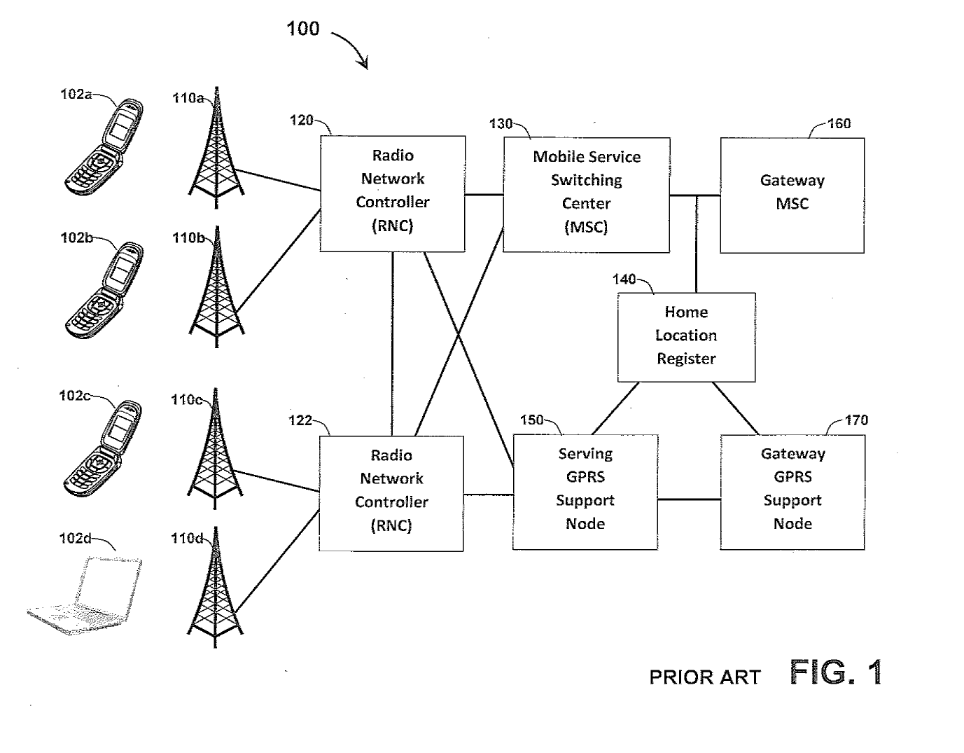

In FIG. 1 there may be seen a simplified block diagram 100 of a portion of a Universal Mobile Telecommunications Services (UMTS) network. Within this network may be found examples of network equipment such as Radio Network Controllers (RNCs) 120 and 122; Mobile Service Switching Centre (MSC) 130; Serving GPRS Support Node 150; Home Location Register Node 140, Gateway Mobile Switching Center 160; and Gateway GPRS Support Node 170. The Radio Network Controllers are connected to base stations 110, in FIG. 1 RNC 120 to NodeB base stations 110a and 110b; and RNC 122 to NodeB base stations 110c and 110d. NodeB base stations can be in radio contact with user equipment 102, depicted in FIG. 1 as handsets 102a, 102b, 102c, and 102d.

In operation the network elements communicate via connections which bind the individual network element to other network elements to form the overall network. The interfaces between network elements terminate on ports of each individual network element. According to the protocol of the specific network, particular messages are exchanged between network elements over the connections in order to accomplish various network functions such as setting up a call, handing off a connection, connecting a particular user equipment to a particular service, etc.

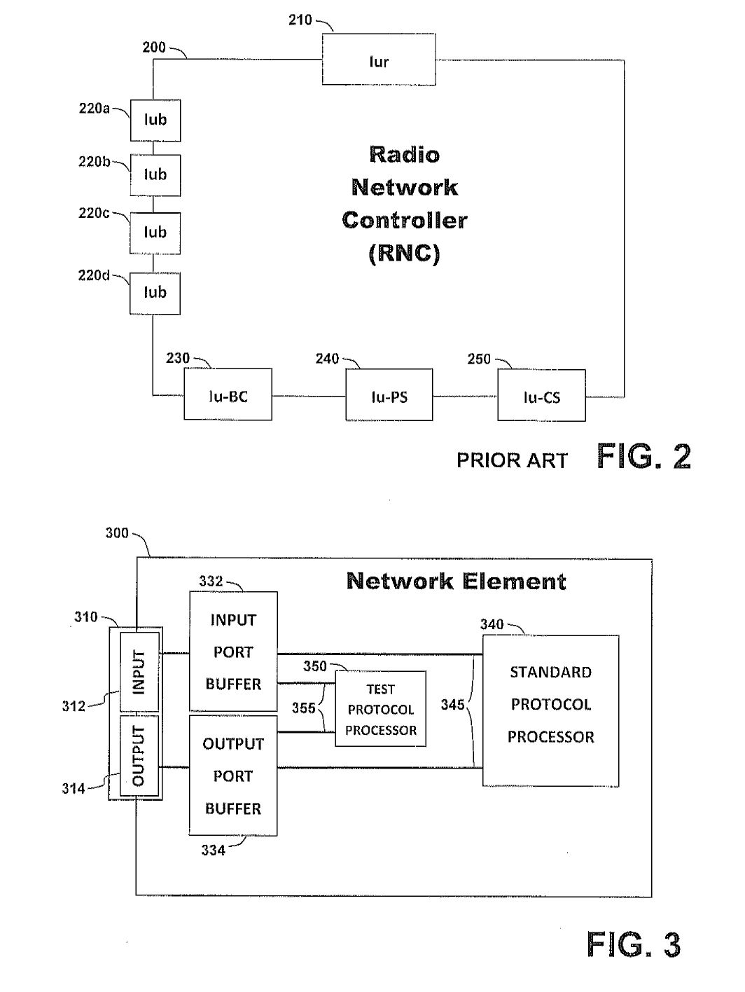

Referring now to FIG. 2 there may be seen a block diagram depicting the ports associated with an example Radio Network Controller network element 200 corresponding to references 120 and 122 of FIG. 1. As per the UMTS specification, RNC 200 has a plurality of ports by which it interfaces connections to other network elements. For the purposes of this explanation, the logical connections between network elements will be termed interfaces. The interface between RNCs, for example RNC 220 and RNC 222 of FIG. 1 is termed the Iur interface and may be seen on FIG. 2 as port 210 of RNC 200. The interface between the RNC and the NodeB units is termed the Iub interface and may be seen on FIG. 2 as ports 220a, 220b, 220c, and 220d of RNC 200. The interface between the RNC and the Cell Broadcast Center (CBC) is termed the Iu-BC interface and may be seen as port 230 of RNC 200. The interface between the RNC and the Serving GPRS Support Node (SGSN) is termed the Iu-PS interface as may be seen as port 240 of RNC 200. The interface between the RNC and the Mobile Switching Center is termed the Iu-CS interface as may be seen as port 250 of RNC 200. Messages over an interface are transmitted and received at ports and will be stored in port buffer memories as discussed regarding the next figure.

Referring to FIG. 3 there may be seen a block diagram of an exemplary network element 300 according to an embodiment of the invention. Network element 300 has an interface port 310 having an input port 312 and output port 314. Messages arriving at interface input port 312 are stored in input port buffer 332. Likewise, messages destined for transmission from interface output port 314 are stored in output port buffer 334.

Standard protocol processor 340 is connected to input port buffer 332 and output port buffer 334 via connections 345. Standard protocol processor 340 represents the hardware and hardware-with-software components of the network element 300 which processes messages received at the interface ports according to a particular protocol to which the incoming messages correspond and which generates messages for transmission from the interface ports also according to a particular protocol to which the outgoing messages correspond.

Standard protocol processor 340 retrieves a message from input port buffer 332, processes the message according to protocol, generates a response message (which may be for an interface port other than the interface port the message was received on), and places the response message into an output port buffer. If the outgoing message is for a second interface port other than a first interface port at which the message was received, then the output port buffer used will be the output port buffer associated with the second interface port.

Also connected to input port buffer 332 and output port buffer 334 via connections 355 is test protocol processor 350. Test protocol processor 350 represents the hardware and hardware-with-software components of the network element 300 which processes messages received at the interface ports and which generates messages for transmission from the interface ports according to the invention. Portions of the test protocol processor 350 may be coterminous with standard protocol processor 340, for example certain elements of hardware such as CPUs or memory may be commonly used by both protocol processors.

According to one embodiment of the invention, in operation test protocol processor 350 monitors input port buffer 332 and under certain conditions removes a message stored within input port buffer 332 prior to standard protocol processor 340 having retrieved it. Subsequently, test protocol processor 350 may replace the message after a delay; may alter the payload of the message and then replace the message; may alter the header of the message and then replace the message; or may not replace the message, effectively dropping the message.

The net result of each of these effects is to change the message, either in contents or in terms of arrival time, in order to examine the response of either the network element 300, or the response of the larger network in which network element 300 is a node. The nature of these changes allows testing of the network element or the larger network in-situ with specifically prescribed message compromising instances. These message compromising instances may be representative of, for example, network delays which may occur in the normal course of network operation.

According to one embodiment of the invention, test protocol processor 350 may replace a particular message in the port input buffer after a delay chosen from a random distribution of delay times. This random distribution may have a defined lower limit and a defined upper limit representative of the range of delays that could be incurred for messages arriving at this port. Further, the random distribution of delay times could be defined by some standard statistical distribution including a uniform random distribution, a truncated Normal random distribution, a truncated Poisson random distribution, or a truncated exponential random distribution.

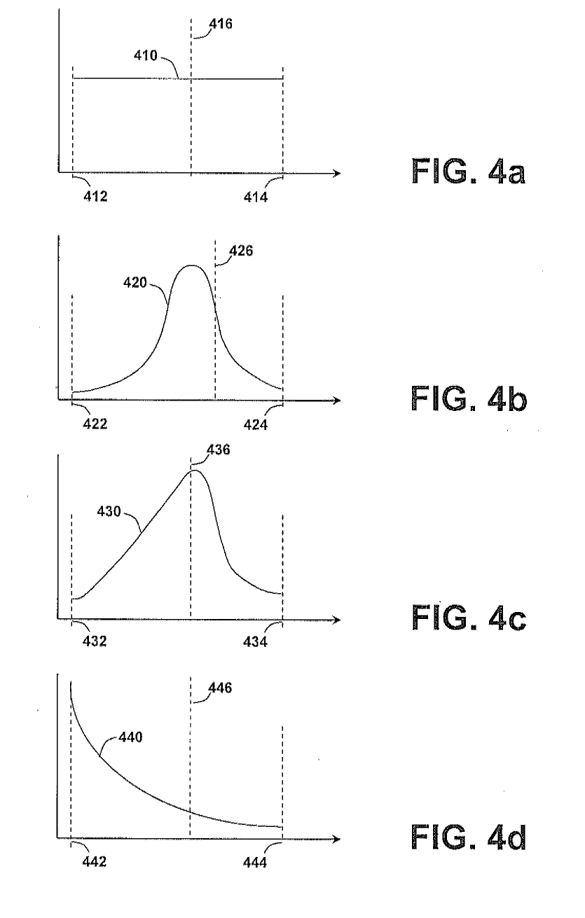

Referring to FIG. 4 there may be seen a variety of random statistical distributions. In FIG. 4a a uniform random distribution is depicted, having a delay range with a lower delay limit 412 and an upper delay limit 414 and having an instantaneous probability 410 throughout the range. A specific delay value 416 is depicted as might result from a delay selection according to this statistical distribution.

In FIG. 4b a truncated Normal random distribution is depicted, having a delay range with a lower delay limit 422 and an upper delay limit 424 and having an instantaneous probability 420 throughout the range. A specific delay value 426 is depicted as might result from a delay selection according to this statistical distribution.

In FIG. 4c a truncated Poisson random distribution is depicted, having a delay range with a lower delay limit 432 and an upper delay limit 434 and having an instantaneous probability 430 throughout the range. A specific delay value 436 is depicted as might result from a delay selection according to this statistical distribution.

In FIG. 4d a truncated Exponential random distribution is depicted, having a delay range with a lower delay limit 442 and an upper delay limit 444 and having an instantaneous probability 440 throughout the range. A specific delay value 446 is depicted as might result from a delay selection according to this statistical distribution.

In application of these embodiments of the invention, the particular random statistical distribution may be chosen to represent the sort of distribution previously observed for messages in the particular network in which the network element of the invention is situated. Alternatively, the distribution may be chosen to demonstrate a particular performance response of the network element.

For example, under some circumstances it may be advantageous to select an appropriate distribution and then provide an upper limit representative of the average delay time. The resulting set of delays would be representative of messages arriving with delays at or below average. The response of the network element under test could be used to demonstrate the degree of impact on Key Performance Indicators that this particular network element contributes when the network is performing at average or below delay times.

According to another embodiment of the invention, the test protocol processor alters the payload of the message prior to returning the message to the input port buffer. This form of test could, for example, be used to evaluate the network element's response to erroneous content values contained in messages, in terms of recovery times and recovery paths taken.

Alternatively, according to another embodiment of the invention, the test protocol processor alters the message header, changing the message type. The alteration could be, for example, the substitution of a failure message in place of the received message. This form of test again could be used to evaluate the network element's response to failure messages, in terms of recovery times and recovery paths taken.

According to yet another embodiment of the invention, the test protocol processor does not return any message to the input port buffer. This form of test would represent the case where an incoming message was dropped.

Under one embodiment of the invention, the conditions under which the test protocol processor would remove a message from the input port buffer are defined in a reference table. The test protocol processor scans arriving messages and when a message corresponds to a message in the reference table, would remove the message from the input port buffer and take an action as correspondingly defined in the reference table. As aforementioned, the kind of actions could include delaying the particular message, changing the payload contents of the message, changing the message type, or even dropping the message. In some embodiments the reference table contains further particulars, for example if a delay is to be incurred by the message the reference table could detail a specific delay or a range of delays. The range could be specified by an upper and lower limit or could also or independently consist of a function reference to a particular type of random distribution with particular characteristics.

In operation the test protocol processor 350 is enabled as part of a testing scenario. The enabling could be via specific operator instructions or automatically in response to an automatic test routine.

According to another embodiment of the invention, in operation test protocol processor 350 monitors output port buffer 334 and under certain conditions removes a message stored within output port buffer 334 prior to the message being sent out over the interface over output port 314. Subsequently, test protocol processor 350 may replace the message after a delay; may alter the payload of the message and then replace the message; may alter the header of the message and then replace the message; or may not replace the message, effectively dropping the message.

The net result of each of these effects is to change the message, either in contents or in terms of arrival time, in order to examine the response of the network element adjacent to network element 300, and additionally the response of the larger network in which the network element adjacent to network element 300 is a node. The embodiment of the invention provides a means of testing adjacent network elements which do not have an embodiment of the invention therein, thus extending the use of the invention.

As per the message delays and alterations, or even message drops, performed on messages in the input port buffer 332, in this embodiment of the invention the test protocol processor may apply all of the same message modifications as previously disclosed in relation to input port buffer 332.

In operation these modifications, delays, and dropping of messages in output port buffer 334 could be triggered by particular message types defined in a reference table. Associated with each message type would be the particular operation that the test protocol processor 350 would perform, including specifics of for example: delay times; message payload changes; message type changes; and instances where the message is to be dropped.

As per the earlier embodiments, in operation the test protocol processor 350 is enabled as part of a testing scenario. The enabling could be via specific operator instructions or automatically in response to an automatic test routine.

As per normal network test procedures, responses of the network element 300 and interacting network elements would be captured in a trace file and logged in a database for later analysis.

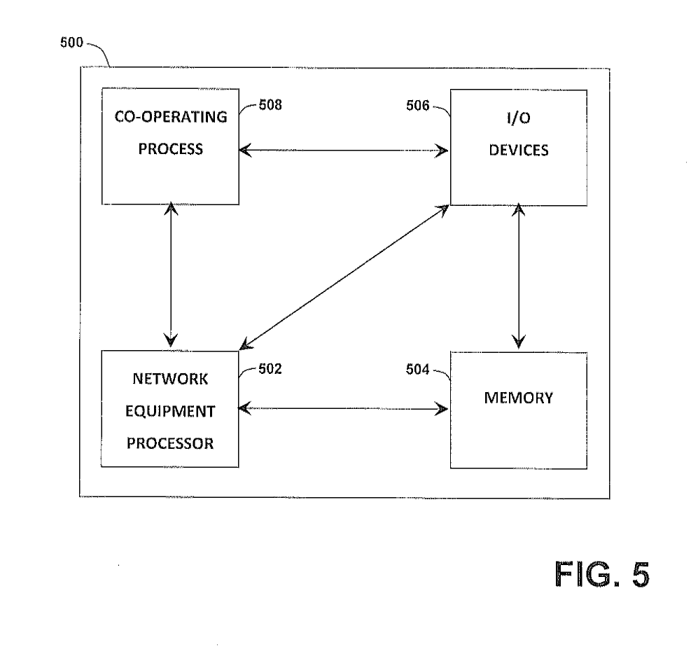

Referring now to FIG. 5 there may be seen a high-level block diagram of a network equipment protocol processor assembly suitable for use in performing functions described herein.

As depicted in FIG. 5, network equipment protocol processor assembly 500 includes a network equipment processor element 502 (e.g., a central processing unit (CPU) and/or other suitable processor(s)), a memory 504 (e.g., random access memory (RAM), read only memory (ROM), and the like), a cooperating module/process 508, and various input/output devices 506 (e.g., a user input device (such as a keyboard, a keypad, a mouse, and the like), a user output device (such as a display, a speaker, and the like), an input port, an output port, a receiver, a transmitter, and storage devices (e.g., a tape drive, a floppy drive, a hard disk drive, a compact disk drive, and the like)).

It will be appreciated that the functions depicted and described herein may be implemented in hardware, for example using one or more application specific integrated circuits (ASIC), and/or any other hardware equivalents. Alternatively, according to one embodiment, the cooperating process 508 can be loaded into memory 504 and executed by network equipment processor 502 to implement the functions as discussed herein. As well, cooperating process 508 (including associated data structures) can be stored on a tangible, non-transitory computer readable storage medium, for example magnetic or optical drive or diskette, semiconductor memory and the like.

Accordingly, what has been disclosed is an apparatus and associated method which provides for the removal of messages from port buffers and subsequent dropping, delaying or alteration of the messages prior to their return to the port buffer. In the event that the port buffer is an input port buffer, the message removal, alteration and replacement (if the message is not dropped) is done prior to the standard protocol processor of the network element having retrieved the message from the input port buffer. In the event that the port buffer is an output port buffer, the message removal, alteration and replacement (if the message is not dropped) is done prior to the message being transmitted from the output port buffer. Thus, what has been provided is a method to test a network element in situ in a customer network. In particular, a means has been disclosed by which the response of a particular network element, functioning within an operational network, to problematic messaging conditions may be demonstrated.

It is contemplated that some of the steps discussed herein as methods may be implemented within hardware, for example, as circuitry that cooperates with the network equipment processor to perform various method steps. Portions of the functions/elements described herein may be implemented as a computer program product wherein computer instructions, when processed by a network equipment processor, adapt the operation of the network equipment processor such that the methods and/or techniques described herein are invoked or otherwise provided. Instructions for invoking the inventive methods may be stored in fixed or removable media, and/or stored within a memory within a computing device operating according to the instructions. It is to be understood that various changes in the details, materials, and arrangements of the parts which have been described and illustrated in order to explain the nature of this invention may be made by those skilled in the art without departing from the scope of the invention as expressed in the following claims.

It should also be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.” Numerous modifications, variations and adaptations may be made to the embodiment of the invention described above without departing from the scope of the invention, which is defined in the claims.

What is claimed is:

1. A network element comprising:
a port having a port buffer;
a standard protocol processor which processes messages stored in said port buffer; and
a test protocol processor having access to said port buffer;
wherein said test protocol processor is configured to:
remove a first protocol message from said port buffer in the event that said first protocol message corresponds to a predetermined message type.

2. The network element of claim 1 wherein
said test protocol processor replaces said first protocol message in said port buffer after a delay.

3. The network element of claim 2 wherein
said delay is chosen from a range of delays having an lower delay limit and an upper delay limit.

4. The network element of claim 3 wherein
a chance of said delay being a particular delay is defined by a random distribution.

5. The network element of claim 4 wherein
the random distribution is a uniform random distribution.

6. The network element of claim 4 wherein
the random distribution is a truncated Normal random distribution.

7. The network element of claim 4 wherein
the random distribution is a truncated Poisson random distribution.

8. The network element of claim 4 wherein
the random distribution is a truncated exponential random distribution.

9. The network element of claim 1 wherein
said test protocol processor replaces said first protocol message in said port buffer after altering the payload contents of said first protocol message.

10. The network element of claim 1 wherein
said test protocol processor replaces said first protocol message in said port buffer with a different protocol message.

11. The network element of claim 10 wherein
said different protocol message is a failure message.

12. The network element of claim 1 wherein
said port buffer comprises an input port buffer of said network element; and
said test protocol processor removes said first protocol message prior to said standard protocol processor processing said message.

13. The network element of claim 1 wherein
said port buffer comprises an output port buffer of said network element and
said test protocol processor removes said first protocol message prior to transmission of said first protocol message from said port.

14. The network element of claim 1 wherein
said predetermined message type is one of a plurality of predetermined message types.

15. A method of testing a performance indicator for a network element having a port having a port buffer; a standard protocol processor which processes messages stored in said port buffer; a test protocol processor having access to said port buffer, and said test protocol processor configured to execute the method; said method comprising the steps of:
checking whether a first protocol message in said port buffer corresponds to a predetermined message; and
removing said first protocol message from said port buffer in the event that said first protocol message in said port buffer does corresponds to said predetermined message.

16. The method of testing as claimed in claim 15 further comprising the step of:
replacing said first protocol message in said port buffer after a delay.

17. The method of testing as claimed in claim 16 further comprising the step of:
choosing said delay from a range of delays having an lower delay limit and an upper delay limit.

18. The method of testing as claimed in claim 17 wherein
a chance of said delay being a particular delay is defined by a random distribution.

19. The method of testing as claimed in claim 17 wherein
the random distribution is one of the set of a uniform random distribution, a truncated Normal random distribution, a truncated Poisson random distribution, and a truncated exponential random distribution.

20. The method of testing as claimed in claim 15 further comprising the step of:
replacing said first protocol message in said port buffer after altering the payload contents of said first protocol message.

21. The method of testing as claimed in claim 15 further comprising the step of:
replacing said first protocol message in said port buffer with a different protocol message.

22. The method of testing as claimed in claim 21 wherein
said different protocol message is a failure message.

23. The method of testing as claimed in claim 15 wherein
said port buffer comprises an input port buffer of said network element; and
said test protocol processor removes said first protocol message prior to said standard protocol processor processing said message.

24. The method of testing as claimed in claim 15 wherein
said port buffer comprises an output port buffer of said network element and
said test protocol processor removes said first protocol message prior to transmission of said first protocol message from said port.

25. The method of testing as claimed in claim 15 wherein
said predetermined message type is one of a plurality of predetermined message types.

26. A tangible and non-transitory machine-readable storage medium encoded with instructions thereon for execution by a test protocol processor; said test protocol processor disposed in a network element having a port having a port buffer; a standard protocol processor which processes messages stored in said port buffer; said test protocol processor having access to said port buffer; said instructions adapting the operation of said test protocol processor to perform a method; the method comprising the steps of:
checking whether a first protocol message in said port buffer corresponds to a predetermined message; and
removing said first protocol message from said port buffer in the event that said first protocol message in said port buffer does corresponds to said predetermined message.

27. The tangible and non-transitory machine-readable storage medium claimed in claim 26 further encoded with instructions thereon for execution by said test protocol processor; said instructions comprising the additional step of:
replacing said first protocol message in said port buffer after a delay.

28. The tangible and non-transitory machine-readable storage medium claimed in claim 26 further encoded with instructions thereon for execution by said test protocol processor; said instructions comprising the additional step of:
replacing said first protocol message in said port buffer after altering the payload contents of said first protocol message.

29. The tangible and non-transitory machine-readable storage medium claimed in claim 26 further encoded with instructions thereon for execution by said test protocol processor; said instructions comprising the additional step of:
replacing said first protocol message in said port buffer with a different protocol message.
